(19) United States
(12) Patent Application Publication
(10) Pub. No.: US 2020/0026255 A1
(43) Pub. Date: Jan. 23, 2020

(54) ABNORMALITY DETECTION DEVICE OF MACHINE TOOL

(71) Applicant: FANUC CORPORATION, Yamanashi (JP)

(72) Inventors: Gaku ISOBE, Yamanashi (JP); Yuuzou INAGUCHI, Yamanashi (JP)

(73) Assignee: FANUC CORPORATION, Yamanashi (JP)

(21) Appl. No.: 16/441,257

(22) Filed: Jun. 14, 2019

(30) Foreign Application Priority Data
Jul. 23, 2018 (JP) 2018-137632

(51) Int. Cl. G05B 19/18; G05B 19/406

(52) U.S. Cl. CPC G05B 19/182; G05B 19/406

(57) ABSTRACT

An abnormality detection device of a machine tool including a spindle and a feed axis and includes: a load monitoring unit that monitors a load of the spindle or the feed axis; as abnormality detection unit that detects an abnormality in the machine tool when the monitored load is equal to or larger than a threshold; a storage unit that stores shape data of the work and shape data of the tool in advance; a non-machining area or machining area calculation unit that calculates a non-machining area in which the tool does not interfere with the work or a machining area in which the tool interferes with the work based on the shape data of the work and the shape data of the tool; and a threshold changing unit that changes a threshold of abnormality detection in the non-machining area to a value lower than a threshold of abnormality detection is the machining area.

This application is based on and claims the benefit of priority from Japanese Patent Application No. 2018-137632, filed on 23 Jul. 2018, the content of which is incorporated herein by reference.

### BACKGROUND OF THE INVENTION

### Field of the Invention

The present invention relates to an abnormality detection device of a machine tool that moves a tool or a work to machine the work.

### Related Art

As a machine tool, a machine which includes a spindle that rotates a tool or a work and a feed axis that moves the tool or the work and which moves the tool and the work in relation to each other to perform machining of the work is known. In such a machine tool, such an abnormality that a tool and a work or a tool and a jig that fixes a work collide (interfere) with each other and an excessively large load is applied to a spindle or a feed axis may occur.

Due to this, a machine tool has a function of monitoring a load of a spindle and a feed axis, detecting an abnormality in a machine when the load exceeds a threshold for a predetermined period, and generating an alarm or the like to stop the machine (for example, see Patent Documents 1 to 3). In this way, when the collision of a tool and a work or the collision of a tool and a jig occurs, it is possible to detect an abnormality in the machine tool immediately and stop the machine immediately. Due to this, it is possible to suppress or prevent deterioration or destruction of components of a machine such as a spindle and a feed axis.

Patent Document 1: Japanese Unexamined Patent Application, Publication No. 2009-285792

Patent Document 2: Japanese Unexamined Patent Application, Publication No. H10-286743

Patent Document 3: Japanese Unexamined Patent Application, Publication No. H07-051997

### SUMMARY OF THE INVENTION

A threshold for abnormality detection of the above-described machine tool needs to be set to be larger than the load applied to the spindle or the feed axis during machining. Due to this, when the collision of a tool and a work or the collision of a tool and a jig occurs, an abnormality in the machine tool may not be detected, the machine may not be stopped, and destruction of components of the machine such as a spindle and a feed axis may not be prevented. Moreover, when a threshold is set to be substantially equal to the load applied to the spindle or the feed axis during machining in order to increase the accuracy of abnormality detection of the machine tool, a variation of the load applied to the spindle or the feed axis may be erroneously detected as the collision of the tool and the work or the collision of the tool and the jig (that is, an abnormality in the machine tool).

An object of the present invention is to provide an abnormality detection device of a machine tool, capable of improving the accuracy of abnormality detection of a machine tool.

(1) An abnormality detection device (for example, an abnormality detection device 10 to be described later) of a machine tool according to the present invention is a controller of a machine tool (for example, a machine tool 1 to be described later) including a spindle (for example, a spindle 2s to be described later) that rotates a tool or a work and a feed axis (for example, a feed axis 2f to be described later) that moves the tool or the work and includes: a load monitoring unit (for example, a load monitoring unit 12 to be described later) that monitors a load of at least one of the spindle and the feed axis; an abnormality detection unit (for example, an abnormality detection unit 14 to be described later) that detects an abnormality in the machine tool when the load of at least one of the spindle and the feed axis monitored by the load monitoring unit is equal to or larger than a threshold; a storage unit (for example, a storage unit 16 to be described later) that stores shape data of the work and shape data of the tool in advance; a non-machining area or machining area calculation unit (for example, a non-machining area or machining area calculation unit 18 to be described later) that calculates at least one of a non-machining area in which the tool does not interfere with the work and a machining area in which the tool interferes with the work on the basis of the shape data of the work and the shape data of the tool; and a threshold changing unit (for example, a threshold changing unit 20 to be described later) that changes a threshold of abnormality detection in the non-machining area to a value lower than a threshold of abnormality detection in the machining area or changes a threshold of abnormality detection in the machining area to a value higher than a threshold of abnormality detection in the non-machining area.

(2) in the abnormality detection device of the machine tool according to (1), the load monitored by the load monitoring unit may be a load torque value or a driving current value.

(3) In the abnormality detection device of the machine tool according to (1) or (2), the storage unit may further store shape data of a jig that fixes the work, and the non-machining area or machining area calculation unit may calculate the non-machining area or the machining area on the basis of the shape data of the work, the shape data of the tool, and the shape data of the jig.

(4) In the abnormality detection device of the machine tool according to any one of (1) to (3), the shape data of the work may be shape data before machining or shape data in the middle of machining.

According to the present invention, it is possible to improve the accuracy of abnormality detection of a machine tool.

### BRIEF DESCRIPTION OF THE DRAWINGS

FIG. 1 is a diagram illustrating a schematic configuration of a machine tool according to the present embodiment.

FIG. 2 is a diagram illustrating a configuration of an abnormality detection device of a machine tool according to the present embodiment.

FIG. 3 is a diagram illustrating a machining area in which a work and a tool interfere with each other.

FIG. 4 is a diagram illustrating a non-machining area in which a work and a tool do not interfere with each other.

### DETAILED DESCRIPTION OF THE INVENTION

Hereinafter, as example of an embodiment of the present invention will be described with reference to the accompanying drawings. The same or corresponding portions in the respective drawings will be denoted by the same reference numerals.

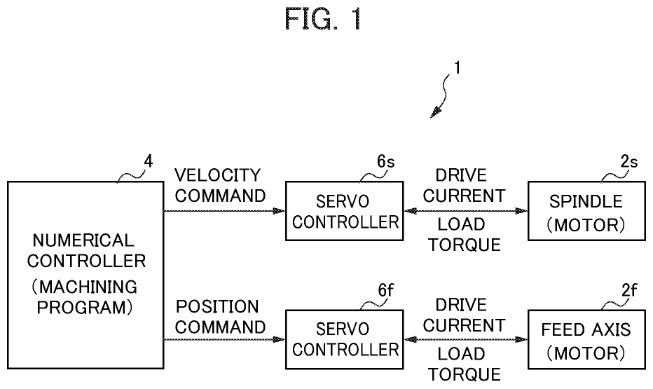

FIG. 1 is a diagram illustrating a schematic configuration of a machine tool according to the present embodiment. A machine tool 1 illustrated in FIG. 1 includes a spindle 2s that rotates a tool (not shown) and a feed axis 2f that moves the tool or a work (not shown) and moves the tool and the work in relation to each other to perform machining (for example, cutting) of the work. The machine tool 1 includes a numerical controller 4, servo controllers 6s and 6f, the spindle 2s, and the feed axis 2f.

Although the feed axis 2f includes five or six axes including three linear axes (X, Y, and Z-axes) and two or three rotary axes (two or all of A, B, and C-axes rotating around the X, Y, and Z-axes), one axis among these axes is illustrated representatively in FIG. 1. Moreover, although five or six servo controllers 6f are provided in correspondence to the feed axes 2f, one servo controller among these servo controllers is illustrated representatively in FIG. 1.

The numerical controller 4 calculates a velocity command on the basis of a machining program and controls the spindle 2s via the servo controller 6s. Moreover, the numerical controller 4 calculates a position command for the feed axis on the basis of the machining program and controls the feed axis 2f via the servo controller 6f.

The servo controller 6s performs velocity control and current control using PI control, for example, on the basis of the velocity command from the numerical controller 4 to calculate a drive current of a motor of the spindle 2s. For example, the servo controller 6s calculates (performs velocity control) a torque command of a motor of the spindle 2s on the basis of a velocity error between the velocity command and a velocity feedback detected by an encoder provided in the motor of the spindle 2s, for example, and calculates (performs current control) a drive current of the motor of the spindle 2s on the basis of the torque command.

The servo controller 6f performs position control, velocity control, and current control using PI control, for example, on the basis of the position command from the numerical controller 4 to calculate a drive current of the motor of the feed axis 2f. For example, the servo controller 6f calculates (performs position control) a velocity command on the basis of a position error between the position command and a position feedback detected by an encoder provided in the motor of the feed axis 2f, for example, calculates (performs velocity control) a torque command of the motor of the feed axis 2f on the basis of the velocity command and the velocity feedback detected by the encoder, and calculates (performs current control) a drive current of the motor of the feed axis 2f on the basis of the torque command.

The spindle 2s includes a spindle motor and rotates with the aid of the spindle motor that drives on the basis of the drive current from the servo controller 6s to thereby rotate the tool. The feed axis 2f includes a feed axis motor and rotates with the aid of the feed axis motor that drives on the basis of the drive current from the servo controller 6f to thereby move the tool or the work.

In such a machine tool 1, such an abnormality that the tool and the work or the tool and a jig that fixes the work collide (interfere) with each other and an excessively large load is applied to the spindle 2s or the feed axis 2f may occur. Due to this, the machine tool 1 includes an abnormality detection device to be described later.

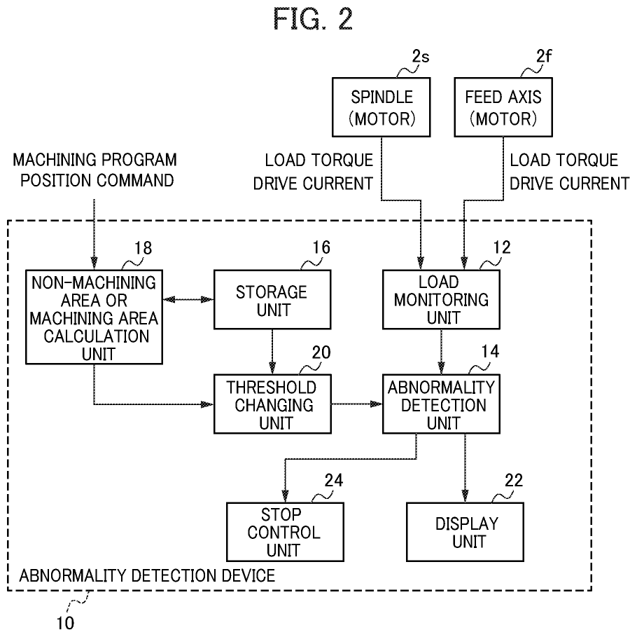

FIG. 2 is a diagram illustrating a configuration of an abnormality detection device of a machine tool according to the present embodiment. The abnormality detection device 10 illustrated in FIG. 2 monitors the load of the spindle 2s and the feed axis 2f and detects an abnormality in the machine tool when the load exceeds a threshold for a predetermined period. Moreover, the abnormality detection device 10 displays an alarm or a message and stops the machine tool 1 when an abnormality in the machine tool is detected. The abnormality detection device 10 includes a load monitoring unit 12, an abnormality detection unit 14, a storage unit 16, a non-machining area or machining area calculation unit 18, a threshold changing unit 20, a display unit 22, and a stop control unit 24.

The abnormality detection device 10 may be provided in the numerical controller 4 illustrated in FIG. 1 and may be provided in the servo controllers 6s and 6f respectively, and may be provided in another controller different from the numerical controller 4 and the servo controllers 6s and 6f. Moreover, the load monitoring unit 12, the abnormality detection unit 14, the storage unit 16, the non-machining area or machining area calculation unit 18, the threshold changing unit 20, the display unit 22, and the stop control unit 24 of the abnormality detection device 10 may be provided separately in any one of the numerical controller 4, the servo controllers 6s and 6f, and another controller. Moreover, the abnormality detection device 10 may be provided so as to perform abnormality detection of a plurality of machine tools that perform the same machining.

The load monitoring unit 12 monitors the load applied to the spindle 2s and the feed axis 2f. For example, the load monitoring unit 12 may monitor the load torque values of the spindle 2s and the feed axis 2f as a load and may monitor the driving current values of the motors of the spindle 2s and the feed axis 2f. The load monitoring unit 12 is a servo amplifier that obtains current feedbacks of the motors of the spindle 2s and the feed axis 2f, for example.

The abnormality detection unit 14 detects an abnormality in the load of the spindle 2s or the feed axis 2f (that is, an abnormality in the machine tool 1) when the load (a load torque value or a driving current value) of any one of the spindle 2s and the feed axis 2f monitored by the load monitoring unit 12 is equal to or larger than a threshold for detecting the abnormality in the load of the spindle 2s and the feed axis 2f for a predetermined period or more.

The threshold for detecting an abnormality in the load of the spindle 2s and the feed axis 2f is a value supplied from the threshold changing unit 20 to be described later, and is a value based on a threshold stored in the storage unit 16 to be described later.

The storage unit 16 stores a threshold for detecting an abnormality in the load of the spindle 2s and the feed axis 2f. This threshold is set to be larger than the load applied to the spindle 2s or the feed axis 2f during machining. Moreover, the storage unit 16 stores shape data of the work, shape data of the tool, and shape data of the jig that fixes the work in advance. The storage unit 16 is a rewritable memory such as EEPROM, for example.

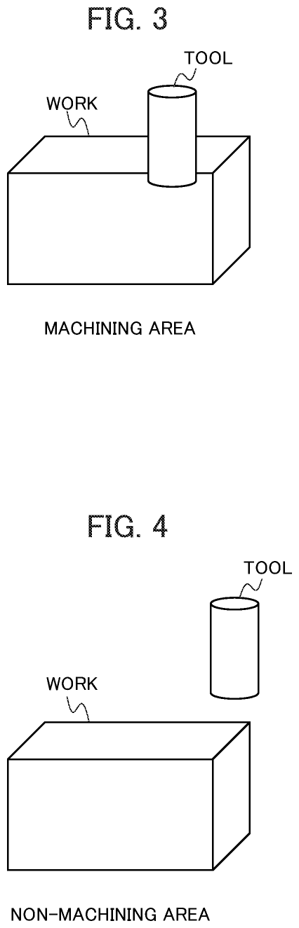

The non-machining area or machining area calculation unit 18 calculates a machining area (for example, a machine coordinate) in which the tool interferes with the work as illustrated in FIG. 3 and a non-machining area (for example, a machine coordinate) in which the tool does not interfere with the work as illustrated in FIG. 4 on the basis of the work shape data, the tool shape data, and the jig shape data stored in the storage unit 16 and the position command information (for example, a machine coordinate) indicated by the machining program from the numerical controller 4. Moreover, the non-machining area or machining area calculation unit 18 may calculate at least one of the machining area and the non-machining area. The non-machining area or machining area calculation unit 18 may temporarily store the information on the machining area and the non-machining area in the storage unit 16.

The work shape data may continuously use the work shape data before machining and may be work shape data that changes with time in the middle of machining. Moreover, the jig shape data may not necessarily be used.

When the present area is calculated as a machining area by the non-machining area or machining area calculation unit 18, the threshold changing unit 20 supplies the threshold of the abnormality detection of the load of spindle 2s and the feed axis 2f (that is, the threshold of the abnormality detection of the machine tool 1) stored in the storage unit 16 as it is On the other hand, when the present area is calculated as the non-machining area by the non-machining area or machining area calculation unit 18, the threshold changing unit 20 changes the threshold of the abnormality detection of the load of the spindle 2s and the feed axis 2f (that is, the threshold of the abnormality detection of the machine tool 1) stored in the storage unit 16 to a lower value and supplies the changed threshold to the abnormality detection unit 14.

That is, the threshold changing unit 20 keeps the threshold of the abnormality detection in the machining area on a value larger than the load applied to the spindle 2s or the feed axis 2f during machining. On the other hand, the threshold changing unit 20 changes the threshold of the abnormality detection in the non-machining area to a value lower than the threshold of the abnormality detection in the machining area.

Here, generally, the threshold of the abnormality detection of the load of the spindle 2s and the feed axis 2f is set to be larger than the load applied to the spindle 2s and the feed axis 2f during machining. In this case, even when the collision of the tool and the work or the collision of the tool and the jig occurs, an abnormality in the machine tool 1 may not be detected. However, according to the present embodiment, since the threshold of the abnormality detection in the non-machining area is changed to a value lower than the threshold of the abnormality detection in the machining area, the accuracy of abnormality detection in the non-machining area is improved.

The display unit 22 displays an alarm or a message when the abnormality detection unit 14 detects an abnormality in the load of the spindle 2s and the feed axis 21 (that is, an abnormality in the machine tool 1). The display unit 22 is a liquid crystal display, for example. In this way, an operator can recognize an abnormality in the machine tool 1 and stop the machine tool 1. As a result, deterioration or destruction of components of the machine tool 1 such as the spindle 2s and the feed axis 2f is suppressed or prevented.

The stop control unit 24 stops the machine tool 1 when the abnormality detection unit 14 detects an abnormality in the load of the spindle 2s and the feed axis 2f (that is, an abnormality in the machine tool 1). As a result, deterioration or destruction of components of the machine tool 1 such as the spindle 2s and the feed axis 2f is suppressed or prevented.

The display unit 22 and the stop control unit 24 may not necessarily be provided. Moreover, when the load (the load torque value or the driving current value) of any one of the spindle 2s and the feed axis 2f monitored by the load monitoring unit 12 is equal to or larger than a first threshold for detection an abnormality in the load of the spindle 2s and the feed axis 2f, the abnormality detection unit 14 may detect a first abnormality in the load of the spindle 2s or the feed axis 2f (that is, a first abnormality in the machine tool 1). When the load (the load torque value or the driving current value) of any one of the spindle 2s and the feed axis 2f monitored by the load monitoring unit 12 is equal to or larger than a second threshold larger than the first threshold, the abnormality detection unit 14 may detect a second abnormality in the load of the spindle 2s or the feed axis 2f (that is, a second abnormality in the machine tool 1). In this case, the display unit 22 may display an alarm or a message when the second abnormality is detected and the stop control unit 24 may stop the machine tool 1 when the second abnormality is detected.

The abnormality detection device 10 (excluding the storage unit 16 and the display unit 22) is configured as an operation processor such as a digital signal processor (DSP) or a field-programmable gate array (FPGA), for example. Various functions of the abnormality detection device 10 are realized by executing predetermined software (program) stored in the storage unit 16, for example. Various functions of the abnormality detection device 10 may be realized by cooperation of hardware and software and may be realized by hardware (electronic circuit) only.

As described above, according to the abnormality detection device 10 for a machine tool of the present embodiment, since the threshold of abnormality detection in the non-machining area is changed to a value lower than the threshold of abnormality detection in the machining area, it is possible to improve the accuracy of abnormality detection of the machine tool in the non-machining area. In this way, when the collision of the tool and the work or the collision of the tool and the jig occurs in the non-machining area, an abnormality in the machine tool 1 is detected and the machine tool 1 is stopped. Due to this, deterioration or destruction of components of the machine tool 1 such as the spindle 2s and the feed axis 2f is suppressed or prevented more reliably.

Moreover, according' to the abnormality detection device 10 of the machine tool of the present embodiment, it is possible to advance the timing of the abnormality detect on of the machine tool 1 in the non-machining area. In this way, it is possible to detect the collision of the tool and the work or the collision of the tool and the jig in the non-machining area more quickly and to stop the machine tool 1 more quickly. Due to this, it is possible to suppress or prevent deterioration or destruction of components of the machine tool 1 such as the spindle 2s and the feed axis 2f more reliably.

Hereinabove, the embodiment of the present invention has been described, the present invention is not limited to the above-described embodiment but various changes and modifications can be made. For example, in the above-described embodiment, the threshold changing unit 20 changes the threshold of the abnormality detection in the non-machining area to a value lower than the threshold of the abnormality detection in the machining area. However, the threshold changing unit 20 may change the threshold of the abnormality detection in the machining area to a value higher than the threshold of the abnormality detection in the non-machining area.

For example, when the present area is calculated as the non-machining area by the non-machining area or machining area calculation unit 18, the threshold changing unit 20 supplies the threshold of the abnormality detection of the load of the spindle 2s and the feed axis 2f (that is, the threshold of the abnormality detection of the machine tool 1) stored in the storage unit 16 to the abnormality detection unit 14 as it is. On the other hand, when the present area is calculated as the machining area by the non-machining area or machining area calculation unit 18, the threshold changing unit 20 changes the threshold of the abnormality detection of the load of the spindle 2s and the feed axis 2f (that is, the threshold of the abnormality detection of the machine tool 1) stored in the storage unit 16 to a higher value and supplies the changed threshold to the abnormality detection unit 14.

Here, when a threshold is set to be substantially equal to the load applied to the spindle or the feed axis during machining in order to increase the accuracy of abnormality detection of the machine tool, a variation of the load applied to the spindle or the feed axis may be erroneously detected as the collision of the tool and the work or the collision of the tool and the jig (that is, an abnormality in the machine tool). However, according to this modification, since the threshold of the abnormality detection in the machining area is changed to a value higher than the threshold of the abnormality detection in the non-machining area, a detection error of the abnormality in the machine tool is suppressed and the accuracy of the abnormality detection in the machining area is improved.

Moreover, in the above-described embodiment, the abnormality detection device 10 of a machine tool that performs cutting has been illustrated. However, the feature of the present invention is not limited thereto but can be applied to an abnormality detection device of a machine tool that performs various machining operations using a spindle and a feed axis.

Moreover, in the above-described embodiment, the abnormality detection device 10 of a machine tool that rotates the tool with the aid of the spindle 2s has been illustrated. However, the feature of the present invention is not limited thereto but can be applied to an abnormality detection device of a machine tool that rotates a work with the aid of a spindle (a machine tool that performs machining of a columnar or cylindrical work).

Moreover, in the above-described embodiment, although the display unit 22 has been illustrated as means for notifying an operator of the fact that the abnormality detection unit 14 has detected an abnormality in the machine tool 1, such a notification means is not limited thereto. For example, the notification means may be a light emitting unit such as one or a plurality of LEDs. When one LED is used, different pieces of information may be notified using blinking/no blinking, for example. Moreover, when a plurality of LEDs is used, different pieces of information may be notified using different colors or the number of blinking LEDs for the same color. Furthermore, for example, the notification means may be a sound generating unit that generates a buzzer sound or a voice.

### EXPLANATION OF REFERENCE NUMERALS

1: Machine tool
2s: Spindle
2f: Feed axis
4: Numerical controller
6s, 6f: Servo controller
10: Abnormality detection device
12: Load monitoring unit
14: Abnormality detection unit
16: Storage unit
18: Non-machining area or machining area calculation unit
20: Threshold changing unit
22: Display unit
24: Stop control unit

What is claimed is:

1. An abnormality detection device of a machine tool including a spindle that rotates a tool or a work and a feed axis that moves the tool or the work, comprising:
a load monitoring unit that monitors a load of at least one of the spindle and the feed axis;
an abnormality detection unit that detects an abnormality in the machine tool when the load of at least one of the spindle and the feed axis monitored by the load monitoring unit is equal to or larger than a threshold;
a storage unit that stores shape data of the work and shape data of the tool in advance;
a non-machining area or machining area calculation unit that calculates at least one of a non-machining area in which the tool does not interfere with the work and a machining area in which the tool interferes with the work on the basis of the shape data of the work and the shape data of the tool; and
a threshold changing unit that changes a threshold of abnormality detection in the non-machining area to a value lower than a threshold of abnormality detection in the machining area or changes a threshold of abnormality detection in the machining area to a value higher than a threshold of abnormality detection in the non-machining area.

2. The abnormality detection device of the machine tool according to claim 1, wherein the load monitored by the load monitoring unit is a load torque value of a driving current value.

3. The abnormality detection device of the machine tool according to claim 1, wherein the storage unit further stores shape data of a jig that fixes the work, and
the non-machining area or machining area calculation unit calculates the non-machining area or the machining area of the basis of the shape data of the work, the shape data of the tool, and the shape data of the jig.

4. The abnormality detection device of the machine tool according to claim 1, wherein the shape data of the work is shape data before machining or shape data in the middle of machining.
